(19) United States
(12) Patent Application Publication
(10) Pub. No.: US 2025/0207922 A1
(43) Pub. Date: Jun. 26, 2025

(54) NAVIGATION METHOD AND APPARATUS, ELECTRONIC DEVICE, STORAGE MEDIUM, AND PROGRAM PRODUCT

(71) Applicant: TENCENT TECHNOLOGY (SHENZHEN) COMPANY LIMITED, SHENZHEN (CN)

(72) Inventors: Wei YAN, SHENZHEN (CN); Chao CHU, SHENZHEN (CN)

(73) Assignee: TENCENT TECHNOLOGY (SHENZHEN) COMPANY LIMITED, SHENZHEN (CN)

(21) Appl. No.: 19/074,755

(22) Filed: Mar. 10, 2025

Related U.S. Application Data
(63) Continuation of application No. PCT/CN2024/078374, filed on Feb. 23, 2024.

(30) Foreign Application Priority Data
Apr. 12, 2023 (CN) 202310427331.2

(51) Int. Cl. G01C 21/34

(52) U.S. Cl. CPC G01C 21/3415; G01C 21/3461

(57) ABSTRACT

A navigation method and apparatus, an electronic device, and a storage medium are provided. The method includes: obtaining a current position and a current navigation route of a vehicle; determining a road type of a road on which the current position is located in a high definition map; when the road type is a diversion road type, predicting, based on the current position in the high definition map, a yawing probability that the vehicle departs from the current navigation route; and generating a re-planned route for the vehicle based on the yawing probability, to guide the vehicle to travel according to the re-planned route. Whether the vehicle is to yaw may be perceived in advance, so that a route is re-planned in advance before the vehicle yaws, to avoid travelling time and fuel consumption caused by yawing, and provide a suitable guidance service for the user in advance.

### RELATED APPLICATIONS

This application is a continuation application of PCT Patent Application No. PCT/CN2024/078374, filed on Feb. 23, 2024, which claims priority to Chinese Patent Application No. 202310427331.2, filed with the China National Intellectual Property Administration on Apr. 12, 2023, both of which are incorporated herein by reference in their entireties.

### FIELD OF THE TECHNOLOGY

The present disclosure relates to the field of computers, and specifically, to navigation.

### BACKGROUND OF THE DISCLOSURE

A current navigation application can help a user find a destination and save time. However, during processing of a yawing scenario, a conventional navigation system reminds the user only when a vehicle departs from a navigation route, and re-generates a new navigation route to remedy the yawing of the vehicle after the vehicle departs from the navigation route. This prompt is usually not timely and clear enough, and consequently, the user may miss a turn or an entrance. As a result, travel time consumption is increased and travel experience deteriorates.

Therefore, current navigation technologies cannot provide a suitable guidance service for the user.

The present disclosure describes embodiments for provide a navigation method, addressing at least one of the problems/issues discussed above, provide a suitable guidance service for a user in a vehicle in advance, improving the performance of the autonomous driving technology.

### SUMMARY

Embodiments of the present disclosure provide a navigation method and apparatus, an electronic device, a storage medium, and a program product, so that yawing of a vehicle can be perceived in advance, to provide a suitable guidance service for a user in advance.

According to an aspect, an embodiment of the present disclosure provides a navigation method, including:
obtaining a current position and a current navigation route of a vehicle;
determining a road type of a road on which the current position is located in a high definition (HD) map;
when the road type is a diverging road type, predicting, based on the current position in the high definition map, a yawing probability that the vehicle departs from the current navigation route; and
generating a re-planned route based on the yawing probability, to guide the vehicle to travel according to the re-planned route.

According to another aspect, an embodiment of the present disclosure further provides a navigation apparatus, including:
an obtaining unit, configured to obtain a current position and a current navigation route of a vehicle;
a road type unit, configured to determine a road type of a road on which the current position is located in a high definition map;
a yawing prediction unit, configured to: when the road type is a diverging road type, predict, based on the current position in the high definition map, a yawing probability that the vehicle departs from the current navigation route; and
a guidance unit, configured to generate a re-planned route based on the yawing probability, to guide the vehicle to travel according to the re-planned route.

According to still another aspect, an embodiment of the present disclosure provides an electronic device, including:
a processor, a communication interface, a memory, and a communication bus;
the processor, the communication interface, and the memory communicating with each other through the communication bus; the communications interface being an interface of a communication module;
the memory being configured to store a computer program; and the processor being configured to invoke the computer program in the memory to perform the method in the foregoing aspect.

According to yet another aspect, an embodiment of the present disclosure provides a storage medium, the storage medium being configured to store a computer program, and the computer program being configured for performing the method in the foregoing aspect.

According to yet another aspect, an embodiment of the present disclosure provides a computer program product including a computer program, the computer program product, when running on a computer, enabling the computer to perform the method in the foregoing aspect.

In the embodiments of the present disclosure, a current position and a current navigation route of a vehicle may be obtained. A road type of a road on which the current position is located in a high definition map is determined. When the road type is a diverging road type, it indicates that the vehicle may not travel according to the current navigation route, and is diverged to another branch. Therefore, in a scenario of the diverging road type, a yawing probability that the vehicle departs from the current navigation route may be predicted based on the current position in the high definition map, to perceive in advance whether the vehicle may yaw. Then, a more accurate and detailed re-planned route is generated when the yawing probability indicates that the vehicle may yaw, to guide the vehicle to change a lane in advance to travel according to the re-planned route. In this way, yawing that occurs due to untimely lane changing when the vehicle travels according to the original navigation route is avoided. In a scenario of a non-diverging road type, because it is impossible for the vehicle to yaw, a navigation system maintains an original navigation solution without occupying excessive computing resources, so that universality of the navigation system is ensured.

This solution may alternatively be applied to a scenario that a preset map is a standard definition (SD) map, that is, the current navigation route of the vehicle is a standard definition route. In comparison with conventional navigation of the standard definition route that easily causes the vehicle to yaw, in this solution, the standard definition route may be converted into a high definition route that is more accurate, so that whether the vehicle may yaw is predicted in advance. Therefore, in the diverging road type in which the vehicle may yaw, a user can obtain more accurate and detailed navigation information, to avoid yawing. For example, if it is perceived in advance that the vehicle may yaw, a route may be re-planned, the user is notified to pay attention to a diverging road ahead, and the user is reminded of turning or changing a lane according to the re-planned route, instead of changing the lane at a location very close to an intersection, so that the user is prevented from missing an exit or entering a wrong lane.

### BRIEF DESCRIPTION OF THE DRAWINGS

FIG. 1a is a schematic diagram of overall operations of a navigation method according to an embodiment of the present disclosure.

FIG. 1b is a schematic flowchart of a navigation method according to an embodiment of the present disclosure.

FIG. 1c is a schematic diagram of a lane crossing scenario of a navigation method according to an embodiment of the present disclosure.

FIG. 1d is a schematic flowchart of yawing prediction of a navigation method according to an embodiment of the present disclosure.

FIG. 2a is a schematic flowchart of similarity determining of a navigation method according to an embodiment of the present disclosure.

FIG. 2b is a schematic diagram of a similarity determining scenario of a navigation method according to an embodiment of the present disclosure.

FIG. 3 is a schematic diagram of a structure of a navigation apparatus according to an embodiment of the present disclosure.

FIG. 4 is a schematic diagram of a structure of an electronic device according to an embodiment of the present disclosure.

### DESCRIPTION OF EMBODIMENTS

The following clearly and completely describes the technical solutions in embodiments of the present disclosure with reference to the accompanying drawings in the embodiments of the present disclosure. It is clear that the described embodiments are some embodiments of the present disclosure rather than all of the embodiments. All other embodiments obtained by a person of ordinary skill in the art based on the embodiments of the present disclosure without creative efforts shall fall within the protection scope of the present disclosure.

Embodiments of the present disclosure provide a navigation method and apparatus, an electronic device, a storage medium, and a program product.

The navigation apparatus may be specifically integrated into the electronic device, and the electronic device may be a device such as a terminal or a server. The terminal includes, but is not limited to, devices such as a mobile phone, a computer, an intelligent speech interaction device, an intelligent household appliance, a vehicle-mounted terminal, and an aircraft. The server may be an independent physical server, or may be a server cluster or distributed system including a plurality of physical servers, or may be a cloud server providing a cloud computing service. The terminal and the server may be directly or indirectly connected through wired or wireless communication. This is not limited in the present disclosure.

In some embodiments, the navigation apparatus may alternatively be integrated into at least one electronic device. For example, the navigation apparatus may be integrated into at least one server, and the at least one server implements the navigation method in the present disclosure.

In some embodiments, the navigation apparatus may alternatively be implemented in a form of a terminal.

The embodiments of the present disclosure may be applied to various technical scenarios, including, but not limited to, a navigation scenario in which a cloud technology, artificial intelligence, intelligent transportation, assisted driving, and the like are used.

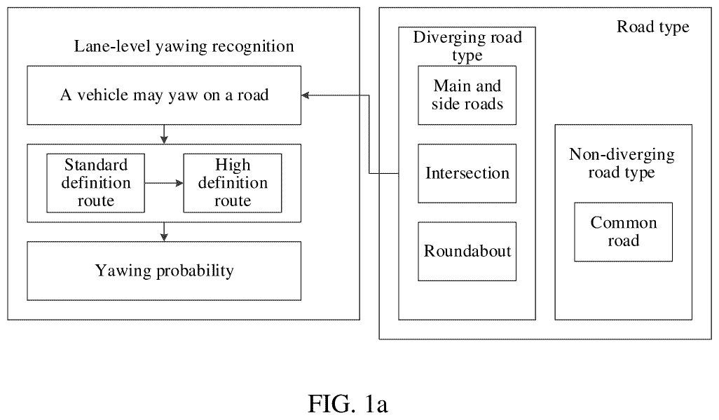

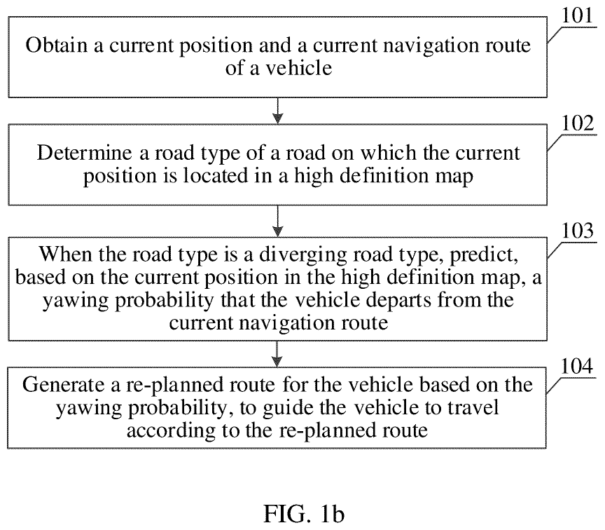

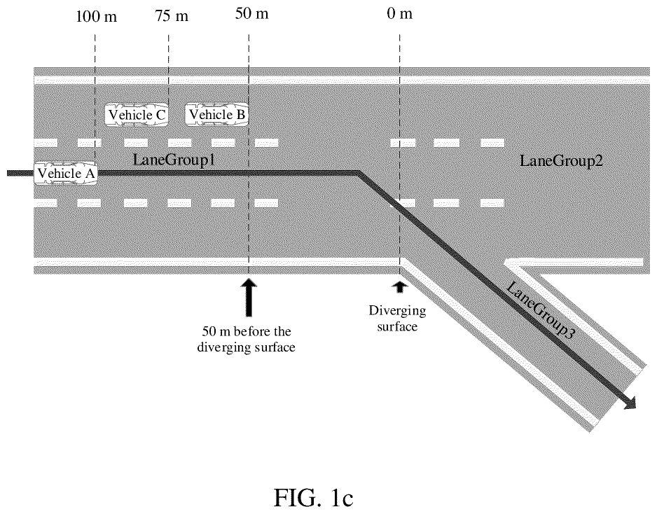

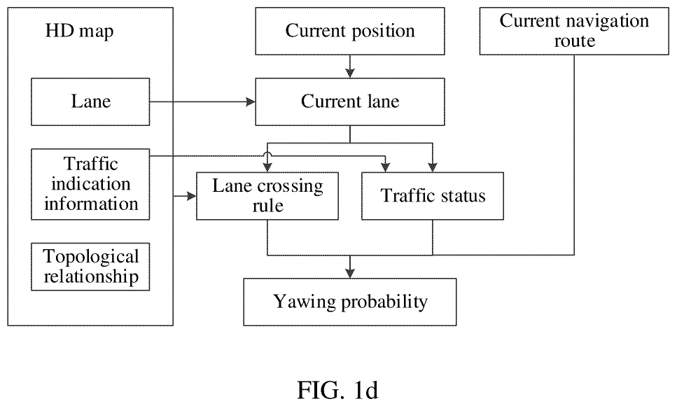

For example, referring to FIG. 1a, the electronic device may implement lane-level yawing recognition, to be specific, may recognize that a vehicle departs from a lane-level navigation route. The electronic device may obtain a current position and a current navigation route of the vehicle, and determine a road type of a road on which the current position is located in a high definition (HD) map. The road type may be classified into a non-diverging road type and a diverging road type. The non-diverging road type includes, but is not limited to, a general road, and the like. The diverging road type includes, but is not limited to, main and side roads, an intersection, a roundabout, and the like. When the road type is the diverging road type, the vehicle may yaw on the road. Therefore, in this solution, a yawing probability that the vehicle departs from the current navigation route may be predicted based on the current position in the high definition map. A re-planned route is generated based on the yawing probability, to guide the vehicle to travel according to the re-planned route. In some embodiments, if the current navigation route is a preset route such as a standard definition route, the current navigation route may be converted into a high definition route. The following describes the preset route, the high definition route, and implementation operations in detail. Details are not described herein.

Detailed descriptions are provided respectively below. Sequence numbers of the following embodiments are not intended to limit a preference sequence of the embodiments.

An autonomous driving technology usually includes technologies such as a high definition map, environment perception, behavioral decision-making, path planning, and motion control. The autonomous driving technology has a wide application prospect.

This embodiment provides a navigation method related to the autonomous driving technology. The method may be performed by an electronic device. In this embodiment, an example in which the electronic device is a terminal is used for description. As shown in FIG. 1b, a specific procedure of the navigation method may include the following operations.

101: Obtain a current position and a current navigation route of a vehicle.

The vehicle may include a motor vehicle, a non-motor vehicle, and the like. For example, the non-motor vehicle may include a bicycle, and the motor vehicle may include a motorcycle, an automobile, a trailer, a forklift, and the like.

The current position of the vehicle may be obtained in a plurality of manners. For example, a location of the vehicle is determined by using a global positioning system (GPS) technology. The GPS system includes a group of satellites, a ground control station, and a receiving device. The receiving device receives signals from at least one satellite and calculates the location of the vehicle by using the signals. The receiving device may be carried on the electronic device provided in the present disclosure, for example, may be carried on a terminal such as a smartphone or a vehicle-mounted terminal. In addition, the current position of the vehicle may alternatively be obtained by using other positioning technologies, such as base station triangulation positioning, Wi-Fi positioning, and an inertial navigation system.

The current navigation route is a navigation route planned by a navigation system for the vehicle at a current moment. The current navigation route may be a route in a preset map, or may be a route in a high definition map.

The preset map is a non-lane-level map that does not directly include or indirectly includes information about the road type, such as a conventional digital map, a standard definition map, and a simplified high definition map. In comparison with a lane-level map, the non-lane-level map has low accuracy and fineness, usually provides only basic information such as a road name and a building name, and does not directly include or indirectly includes the information about the road type. A definition of the road type is shown in the following operation 102.

For example, the preset map is a map that does not directly include the information about the road type. In some embodiments, the information about the road type, for example, data that can directly reflect the road type, such as a shape and an outline of the road, topology information of a lane, and an accurate landform and terrain, can be captured and presented in a map production process. The preset map may not include the data.

The preset map is a map that does not indirectly include the information about the road type. In some embodiments, a road type of the road can be indirectly obtained based on a lane line on the road. Therefore, the preset map is a map that does not include data of the lane line.

The lane line is a marking line on the road, and is configured to indicate a travelling direction of the vehicle. The HD map is a lane-level map that directly or indirectly includes the information about the road type, and is usually configured for high-accuracy positioning and navigation application for a self-driving automobile and the like. The HD map includes detailed information such as the road, the lane, a traffic light, a building, and the landform, and accuracy of the HD map may reach a sub-meter level. The SD map is usually used for applications such as common automobile navigation and travel planning. The SD map has low accuracy and fineness, and includes only information such as a main road, a traffic sign, and a landmark. An HD route and an SD route are navigation routes based on different types of maps. Calculation methods and principles of the HD route and the SD route are basically the same. However, different maps are used when the routes are generated, causing different accuracy and fineness of the calculated routes. The HD route is a more accurate navigation route that may be calculated by using the HD map, and is more suitable for high-accuracy application such as the autonomous driving. The SD route is a navigation route generated based on the SD map, and is more suitable for application such as common automobile navigation.

In this embodiment of the present disclosure, the current navigation route may be the HD route, or may be a preset route. In some embodiments, the preset route may be the SD route. This solution may alternatively be implemented when the preset route is not the SD route, and it is not limited that the preset route needs to be the SD route. However, for ease of understanding, the following uses an example in which the preset map is the SD map and the preset route is the SD route.

In this embodiment of the present disclosure, if the current navigation route is the SD route (which is also denoted as a preset navigation route), definition conversion may be performed on the SD route, to obtain the HD route. An embodiment is provided in the second part in this specification to specifically explain how to implement definition conversion. Therefore, details are not described herein.

102: Determine a road type of a road on which the current position is located in the high definition map.

The road type may be classified into a diverging road type and a non-diverging road type based on a feature of whether the road is diverged. The diverging road type may include an intersection, main and side roads, a roundabout, and the like, and the non-diverging road type may include a one-way road and the like. Therefore, a road of the non-diverging road type means that the vehicle travels forward along the road. In this case, a travelling route of the vehicle is certainly forward along the road the same as the current navigation route, and there is no possibility of yawing. A road of the diverging road type means that the vehicle may travel straight, turn right, turn left, make a U-turn, or the like in addition to travelling forward, when travelling on the road. Therefore, the travelling route of the vehicle is not necessarily the same as the current navigation route. In this case, when travelling on the road of the diverging road type, the vehicle may yaw because of a user being distracted, making a mistake, or getting lost.

In some embodiments, the road may include at least one lane group, and each lane group may include at least one lane. Therefore, operation 102 may be determining a road type of a lane on which the current position is located in the high definition map. The road type of the lane may be the diverging road type such as the intersection, a crossroad, a T-intersection, the main and side roads, or the roundabout, or may be the non-diverging road type such as the one-way road, a common road, or a tunnel entrance.

In some embodiments, a road type of each road in the high definition map may be preset. Therefore, operation 102 may be implemented by directly reading the high definition map. In some embodiments, the road type of the road in the high definition map may alternatively be determined based on a topological relationship of each road.

If a downstream topology of the lane group is not unique, it indicates that the vehicle may travel forward along different directions/routes when continuing to travel. Therefore, in some embodiments, the road may include the lane group, the lane group may include the lane, and operation 102 may include the following operations:
determining a quantity of downstream lane groups of a current lane group, the current lane group being a lane group in which the current position is located in the high definition map; and
determining the road type of the road on which the current position is located in the high definition map as the non-diverging road type when the quantity of downstream lane groups of the current lane group is 1; and/or
determining the road type of the road on which the current position is located in the high definition map as the diverging road type when the quantity of downstream lane groups of the current lane group is greater than 1.

The downstream lane group of the current lane group is a lane group that is downstream of the current lane group and adjacent to the current lane group.

In some implementations, the operation 102 may include the following operations: determining a quantity of all downstream lane groups of a current lane group, the current lane group being a lane group in which the current position is located in the high definition map; and
determining the road type of the road on which the current position is located in the high definition map as the non-diverging road type when the quantity of all downstream lane groups of the current lane group is 1; or determining the road type of the road on which the current position is located in the high definition map as the diverging road type when the quantity of all downstream lane groups of the current lane group is greater than 1.

In some implementations, all downstream lane groups include all lane groups that are downstream of the current lane group and are adjacent to the current lane group.

There are a plurality of manners of determining the quantity of downstream lane groups of the current lane group. For example, a topological relationship between lanes may be determined based on lane topology data that is preset in the HD map, and the topological relationship may be preset, or may be obtained from a real-time topology of the HD map during application. In addition, the quantity of downstream lane groups may be determined based on the topological relationship, a road attribute, a road level, and the like recorded in the HD map.

For example, a quantity of downstream lane groups of a straight lane is obtained through the topology and is 1, indicating that the vehicle can only travel forward and has no possibility of yawing. In this case, the road type of the lane group is the non-diverging road type. For example, a quantity of downstream lane groups of the main and side roads is obtained through the topology and is 2, indicating that the vehicle may travel forward or may turn. In this case, the road type of the lane group is the diverging road type. A quantity of downstream lane groups of the crossroad is obtained through the topology and is 4, indicating that a possible direction to which the vehicle travels is straight, turning right, turning left, or making a U-turn. In this case, the road type of the lane group is the diverging road type.

When the quantity of downstream lane groups of the current lane group is analyzed, whether the vehicle is to enter a road segment in which yawing may occur can be effectively determined, and a possible yawing risk can be determined in advance.

In this solution, because there is no probability that yawing occurs on the road of the non-diverging road type, only a case in which the road type is the diverging road type needs to be discussed.

103: When the road type is the diverging road type, predict, based on the current position in the high definition map, a yawing probability that the vehicle departs from the current navigation route.

The yawing probability may include a first value and a second value, where the first value represents that the vehicle is not to depart from the current navigation route, and the second value represents that the vehicle is to depart from the current navigation route.

In this solution, whether the vehicle may subsequently travel along the current navigation route may be determined based on the current position of the vehicle. For example, referring to FIG. 1c, it is assumed that current navigation routes of three vehicles A, B, and C are all routes LaneGroup 1+LaneGroup 3, and locations of the three vehicles are respectively 100 m, 50 m, and 75 m before a diverging surface. According to a traffic rule, the vehicle needs to complete lane changing at a location that is at least 50 m before the diverging surface. Therefore, whether the vehicle can safely and compliantly travel along the current navigation route may be predicted based on the current position of the vehicle:
(1) The vehicle A needs to cross one lane within next 50 m to successfully reach the LaneGroup 3.
(2) The vehicle B needs to cross two lanes within next 0 m, and cannot reach the LaneGroup 3. Therefore, it can be learned that the vehicle B is to yaw.
3) The vehicle C needs to cross two lanes within next 25 m to successfully reach the LaneGroup 3.

In some embodiments, to more accurately predict the yawing probability that the vehicle departs from the current navigation route, whether the vehicle is to yaw may further be determined based on a current travelling status of the vehicle. The current travelling status of the vehicle may include a current speed, heading, acceleration, and the like of the vehicle.

For example, the vehicle A needs to cross one lane within 50 m and the vehicle B needs to cross two lanes within 25 m, so that both vehicles are not to yaw. Whether this action can be implemented depends on speeds and headings of the vehicle A and the vehicle C. If the vehicle C is not fast and a heading angle of the vehicle C is large, in other words, the vehicle C has a tendency to change lanes, the vehicle C may be able to reach the LaneGroup 3. If the vehicle A is fast, and the heading of the vehicle A is along a direction of a road, the vehicle A cannot cross one lane within 50 m to reach the LaneGroup 3. As a result, the vehicle A is to yaw.

In some embodiments, the road may include the lane group, the lane group may include the lane, the road may include the diverging surface, the current navigation route is a high definition navigation route, and operation 103 may include the following operations:
determining, based on the high definition map, a crossing quantity of lanes crossed by the vehicle to travel from a start lane to an end lane group;
determining a minimum lane crossing distance required by the vehicle to cross the crossing quantity of lanes in the current travelling status; and
determining the yawing probability as the first value if the minimum lane crossing distance is less than a current buffer distance, the first value representing that the vehicle is not to depart from the current navigation route; and/or
determining the yawing probability as the second value if the minimum lane crossing distance is not less than the current buffer distance, the second value representing that the vehicle is to depart from the current navigation route.

The current buffer distance is a distance between the current position and a position at a preset length before the diverging surface. In some implementations, the position at the preset length before the diverging surface may also be referred as a position at a preset distance in front of the diverging surface. A start lane group may include the start lane, and the start lane is a lane that in the current navigation route and from which the vehicle travels from the current position of the vehicle to the diverging surface. The end lane group may include an end lane, the end lane is a lane that is adjacent to the diverging surface in the current navigation route, and further, the end lane is a lane that is adjacent to the start lane and the diverging surface in the current navigation route. The crossing quantity refers to a quantity of lanes between the start lane and the end lane group plus one. The current buffer distance is the distance between the current position and the position preset length before the diverging surface. The preset length may be set according to the traffic rule and a safe driving scenario. For example, referring to FIG. 1c, the preset length may be set to 50 m.

The minimum lane crossing distance may be calculated based on the current travelling status of the vehicle, such as the speed, the heading, and the acceleration. For example, a track of a lane crossed by the vehicle to travel from the start lane to the end lane group may be considered as a track function in a form of an exponential function, a parabolic function, a linear function, or the like. In this way, the current travelling status of the vehicle may be substituted into the track function, so that the minimum lane crossing distance may be determined.

In some embodiments, the exponential function may be used as the track function if the vehicle is far away from the diverging surface. For example, the exponential function may be used as the track function if the vehicle is more than 300 m from the diverging surface. In some embodiments, the linear function may be used as the track function if the vehicle is close to the diverging surface. For example, the linear function may be used as the track function if the vehicle is less than 300 m from the diverging surface.

For example, referring to FIG. 1c, current buffer distances of the three vehicles A, B, and C are respectively 50 m, 0 m, and 25 m. It is assumed that minimum lane crossing distances of the vehicles A, B, and C are respectively 35 m, 20 m, and 20 m. For the vehicle A, the current buffer distance of 50 m is greater than the minimum lane crossing distance of 35 m, so that there is sufficient buffer distance for the vehicle A to complete lane changing before reaching the location that is 50 m before the diverging surface. Therefore, a yawing probability of the vehicle A is the first value. For the vehicle B, the current buffer distance of 0 m is less than the minimum lane crossing distance of 20 m, so that there is no sufficient buffer distance for the vehicle B to complete lane changing before reaching the location that is 50 m before the diverging surface. Therefore, a yawing probability of the vehicle B is the second value. For the vehicle C, the current buffer distance of 25 m is greater than the minimum lane crossing distance of 20 m, so that the vehicle C may complete lane changing before reaching the location that is 50 m before the diverging surface. Therefore, a yawing probability of the vehicle C is the first value.

When the quantity of lanes that the vehicle needs to cross before entering the diverging surface from a current lane is determined based on the high definition map, whether there is a sufficient buffer distance for the vehicle to enter the diverging surface may be determined based on the current travelling status of the vehicle. In other words, a probability that the vehicle departs from a current road even if the vehicle directly travels to the diverging surface from the current position is determined based on an actual travelling condition, so that the determined yawing probability better conforms to the current travelling status, and has higher accuracy.

To further improve prediction accuracy of the yawing probability, referring to FIG. 1d, whether a key lane in the end lane group is open to traffic may be further determined based on traffic indication information such as lane line data, traffic light information, and lane indicating information. When the yawing probability is predicted, only an end lane that is open to traffic is considered. For example, a straight ahead arrow, a left turn arrow, and the like that are common on the intersection indicate that a lane only allows going straight, turning left, and the like. If the current navigation route is turning right, and there is only the straight ahead arrow in a lane on which the vehicle is located, it indicates that the vehicle can only go straight after passing the diverging surface. As a result, the vehicle cannot travel along the current navigation route, and has to yaw.

Therefore, in some embodiments, the predict, based on the current position in the high definition map, a yawing probability that the vehicle departs from the current navigation route may further include the following operations:
obtaining the traffic indication information;
determining, based on the traffic indication information, a traffic status of the end lane to which the vehicle travels from the start lane; and
determining the yawing probability as the second value if the traffic status of the end lane is a closed-to-traffic state.

The traffic status indicates whether the vehicle can travel from the start lane to the end lane, and may be classified into two states, namely, an open-to traffic-state and the closed-to-traffic state.

The traffic indication information may include the lane line data, the traffic light information, the lane indicating information, sign information, and the like. The traffic indication information may be obtained from the HD map, may be collected by using a sensor, may be obtained from a real-time traffic information database of a traffic management department, or the like.

In some embodiments, the current navigation route is the preset navigation route. The preset navigation route, as described above, is a navigation route in the SD map. The preset navigation route may be considered as a point string, to be specific, may include a series of line segments, and accuracy of a location point is approximately 5 m to 10 m. The HD route (that is, the high definition navigation route) includes a series of spliced faces, and accuracy is in a decimeter level.

When operation 103 is performed, the SD route needs to be converted into the HD route, that is, the preset navigation route needs to be converted into the high definition navigation route. Therefore, operation 103 may include the following operations:
when the road type is the diverging road type, performing definition conversion on the preset navigation route, to obtain the high definition navigation route; and
predicting, based on the current position in the high definition map, a yawing probability that the vehicle departs from the high definition navigation route.

An operation of definition conversion is explained in detail in the second part in this specification, and details are not described herein.

When the preset navigation route is converted into the high definition navigation route, more detailed road information of the preset navigation route can be obtained, to improve accuracy of determining the yawing probability.

104: Generate a re-planned route based on the yawing probability, to guide the vehicle to travel according to the re-planned route.

In some embodiments, if the yawing probability indicates that the vehicle is to yaw, the re-planned route may be provided for the user. If the yawing probability indicates that the vehicle is not to yaw, the current navigation route may not be modified and adjusted.

For example, referring to FIG. 1c, if the vehicle B uses this solution, when the vehicle B travels into the LaneGroup 1, a navigation system provided in this solution may perform operation 101 to operation 104. Once the vehicle B is close to the diverging surface and it is predicted that the vehicle may yaw, the vehicle may be guided to travel according to the re-planned route immediately, so that the vehicle B travels into the LaneGroup 3, different from the related art in which the vehicle B is not reminded and a new route is not re-planned for the vehicle B until the vehicle B travels into the LaneGroup 2.

Therefore, in some embodiments, operation 104 may include the following operations:
guiding the vehicle into the end lane group if the yawing probability is the first value; or
generating the re-planned route and guiding the vehicle to travel according to the re-planned route if the yawing probability is the second value.

For example, if the yawing probability is the first value, that is, the vehicle is not to yaw, the user may be prompted, by using voice at a location that is 200 m before the diverging surface, to drive according to the current navigation route. If the yawing probability is the second value, that is, the vehicle is to yaw, a more accurate and detailed re-planned route is generated, and the vehicle is guided to travel along the re-planned route, so that the vehicle is guided to change a lane in advance, to avoid yawing caused by untimely lane changing.

In addition to being applied to a vehicle traffic scenario, this solution may also be applied to scenarios such as logistics transportation and robot pathfinding. For example, this solution may be applied to a mechanical device that is movable and that can find a path automatically, such as a robotic vacuum cleaner or a robotic pet, to provide a suitable guidance service for the mechanical device.

In this embodiment of the present disclosure, the current position and the current navigation route of the vehicle may be obtained. The road type of the road on which the current position is located in the high definition map is determined. When the road type is the diverging road type, the yawing probability that the vehicle departs from the current navigation route is predicted based on the current position in the high definition map. The re-planned route is generated based on the yawing probability, to guide the vehicle to travel according to the re-planned route. In this way, in this embodiment of the present disclosure, whether the vehicle is to yaw may be perceived in advance, to re-plan a route for the user in advance before the vehicle yaws, so that travelling time consumption caused by yawing is avoided. Therefore, in this embodiment of the present disclosure, yawing of the vehicle may be perceived in advance, to provide a suitable guidance service for the user in advance.

According to the method described in the foregoing embodiment, the following further describes route definition conversion in detail.

In this embodiment, definition conversion is described in detail.

Because development of the HD map starts late, currently, most applications and functions based on the HD map need to be supported by a basic SD map. Theoretically, planning a navigation route by using the HD map may have higher complexity and a larger data volume. Therefore, in some embodiments, if the current navigation route is an HD route and a data volume of the current navigation route is acceptable, the operation of definition conversion does not need to be performed. If the current navigation route is an SD route, the current navigation route may be converted into an HD route by using the HD map.

In some embodiments, although the SD route is not as good as the HD route in terms of accuracy and details, because the vehicle does not yaw when travelling on the road of the non-diverging road type, the SD route with a smaller data volume can satisfy a navigation requirement. However, when the vehicle travels on the road of the diverging road type road that may cause the vehicle to yaw, a more accurate and detailed HD route is required for navigation. In this solution, the more accurate and detailed HD route may be generated based on the SD route with the smaller data volume, so that both the data volume and navigation accuracy are considered. In this way, terminals with various hardware configurations may all be provided with the navigation system provided in this solution, to ensure universality of this solution.

In some embodiments, the navigation system provided in this solution may display the navigation route on a navigation interface, to facilitate understanding of a navigation solution by the user. A map may be displayed on the navigation interface, and the map may be the SD map or the HD map. After definition conversion is performed on the navigation route, the navigation interface may be correspondingly switched.

In some embodiments, to consider both the data volume and the navigation accuracy and ensure the universality of the navigation system, before the definition conversion, the SD map may be displayed on the navigation interface, and an original SD route may be displayed in the SD map. After the definition conversion, the SD map in the navigation interface may be switched to the HD map, and the HD route obtained through the definition conversion may be presented in the HD map.

In some embodiments, to ensure reading experience on the interface, the map on the interface may not be switched. For example, the SD map may be always displayed on the navigation interface. Before the definition conversion, the original SD route may be displayed in the SD map, and after the definition conversion, the HD route obtained through the definition conversion may be displayed in the SD map.

Similarly, in some embodiments, the HD map may alternatively be always displayed on the navigation interface. Before the definition conversion, the original SD route may be displayed in the HD map, and after the definition conversion, the HD route obtained through the definition conversion may be displayed in the HD map.

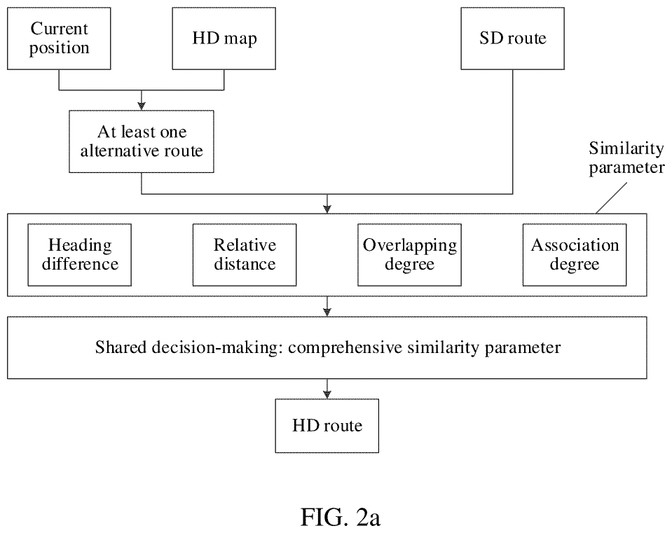

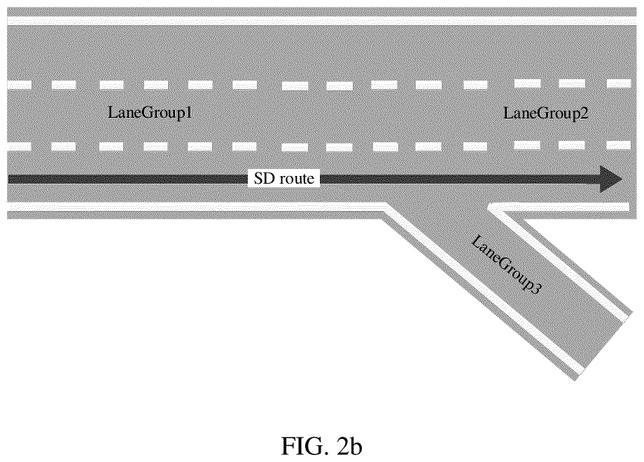

As shown in FIG. 2a, in some embodiments, the performing definition conversion on a standard definition navigation route, to obtain the high definition navigation route may include the following operations:

(1) Determine alternative routes based on the high definition map, the current position of the vehicle being located in the alternative routes.

In some embodiments, all routes that include the current position and that are in the high definition map may be used as the alternative routes. There are a plurality of methods for determining the alternative routes. For example, in some embodiments, the alternative routes including the current position may be determined by traversing the high definition map. For example, in some embodiments, all routes including the current lane group in which the current position is located may be used as the alternative routes.

In some embodiments, after the road type of the current road is determined based on the topological relationship, the road attribute, the road level, and the like, the alternative routes may also be determined based on information such as the topological relationship, the road attribute, and the road level.

(2) Determine, from the alternative routes, a route that is most similar to the definition navigation route as the high definition navigation route.

The current position of the vehicle is used as a basis for screening the alternative routes, so that all routes related to the current position may be obtained as the alternative routes by traversing the high definition map, to determine the high definition navigation route. Therefore, accuracy of determining the high definition navigation route is effectively improved.

In some embodiments, a most similar high definition navigation route may be determined by a route similarity parameter between each of the alternative routes and the standard definition navigation route. Therefore, operation (2) may include the following operations:

21: Determine a similarity parameter between each of the alternative routes and the standard definition navigation route.

22: Determine a comprehensive similarity parameter between each of the alternative routes and the standard definition navigation route, based on the similarity parameter.

23: Determine, based on the comprehensive similarity parameter, a most similar route from the alternative routes as the high definition navigation route.

The similarity parameter is a parameter used for measuring similarity between the alternative route and the standard definition navigation route. The similarity parameter may include, but is not limited to, a heading difference, a relative distance, an overlapping degree, an association degree, a route length, time consumption of the route, and the like.

The comprehensive similarity parameter may be obtained by performing weighted summation on the foregoing similarity parameters.

For example, in some embodiments, any similarity parameter such as the heading difference, the relative distance, the overlapping degree, or the association degree may be directly used as the comprehensive similarity parameter between each of the alternative routes and the standard definition navigation route. For example, in some embodiments, the similarity parameters such as the heading difference, the relative distance, the overlapping degree, and the association degree may be considered together in decision-making, to obtain the similarity parameter between each of the alternative routes and the standard definition navigation route.

The SD route includes a plurality of points, and the HD route includes a plurality of lanes/lane groups. Therefore, a wholeness similarity parameter between each of the alternative routes and the standard definition navigation route may be obtained based on a local similarity parameter between a point in the SD route and a lane/lane group in the HD route. For example, the wholeness similarity parameter may be obtained by averaging, calculating a minimum value for, or calculating a maximum value for all the locality similarity parameters.

The high definition navigation route that actually represents the preset navigation route can be accurately determined from the alternative routes based on the similarity parameter used for identifying similarity between two routes. Information embodied by the determined high definition navigation route better conforms to an actual road condition of the preset navigation route, so that accuracy of a subsequent yawing probability is effectively improved.

Therefore, in some embodiments, the similarity parameter may include the heading difference, and operation 21 may include the following operations:
obtaining headings of the alternative routes and the standard definition navigation route;
calculating a heading difference between each of the alternative routes and the standard definition navigation route based on the headings of the alternative routes and the standard definition navigation route.

In some embodiments, a difference between a heading of the point in the SD route and a heading of the lane/lane group in the HD route is obtained, and a smallest heading difference is used as the similarity parameter. For example, in some embodiments, the difference between the heading of the point in the SD route and the heading of the lane/lane group in the HD route is obtained, an average value is calculated, and an average heading difference is used as the similarity parameter.

For example, heading data of the SD route is compared with heading data of the HD route, and a smallest difference between two heading values is calculated and used as the smallest heading difference.

In some embodiments, if all points in the SD route fall within the lane/lane group in the HD route, it may be determined that the SD route and the HD route are similar. Therefore, the similarity parameter may include the overlapping degree, the standard definition navigation route may include points in the standard definition navigation route, and operation 21 may include the following operations:
determining an overlapping point from the points in the standard definition navigation route, the overlapping point being a point that is in the standard definition navigation route and that overlaps the alternative route; and
determining an overlapping degree between the standard definition navigation route and each of the alternative routes based on a quantity of overlapping points.

In some embodiments, a ratio of the quantity of overlapping points to a quantity of all points in the standard definition navigation route may be used as the similarity parameter. For example, in some embodiments, the quantity of overlapping points may be directly used as the similarity parameter.

For example, points on the SD route and points on the HD route are matched, an overlapping length of the two routes is calculated, and then the overlapping degree is obtained by dividing the overlapping length by a total length. A distance calculation method or a coordinate-based method may be used to match the points.

In some embodiments, the similarity parameter may include the relative distance, and operation 21 may include the following operations:
obtaining route locations of the alternative routes and the standard definition navigation route;
calculating a relative distance between each of the alternative routes and the standard definition navigation route, based on the route locations of the alternative routes and the standard definition navigation route.

For example, in some embodiments, a distance between the SD route and the HD route is calculated, and a smallest distance is used as the similarity parameter. For example, in some embodiments, an average distance may be used as the similarity parameter.

In some embodiments, the similarity parameter may include the association degree, and operation 21 may include the following operations:
obtaining the association relationship between each of the alternative routes and the standard definition navigation route;
calculating an association degree between the standard definition navigation route and each of the alternative routes based on the association relationship between each of the alternative routes and the standard definition navigation route.

The association relationship between each of the alternative routes and the standard definition navigation route refers to an SD-HD association relationship. In some embodiments, when producing the SD map and the HD map, a skilled person may simultaneously produce an association relationship between the SD map and the HD map. The association relationship directly indicates a mapping relationship between the point in the SD route and the lane group in the HD route. Therefore, in some embodiments, a route may be directly determined based on this relationship.

In some embodiments, operation 22 may include the following operations:
determining the comprehensive similarity parameter between each of the alternative routes and the standard definition navigation route, based on the heading difference, the relative distance, the overlapping degree, and the association degree; and
determining a most similar high definition navigation route in the alternative routes, based on the comprehensive similarity parameter. In some implementations, the above step may, instead, include determining, based on the comprehensive similarity parameter, the most similar route from the alternative routes as the high definition navigation route.

For example, weighted summation may be performed on the similarity parameters such as the heading difference, the relative distance, the overlapping degree, and the association degree, to obtain the comprehensive similarity parameter. A weight may be pre-designed based on an actual scenario.

For example, referring to FIG. 2b, at an intersection of the main and side roads, the current navigation route, that is, the SD route, is travelling from the left to the right. Based on a topological relationship, a downstream topology of a LaneGroup 1 is a LaneGroup 2 and a LaneGroup 3. Therefore, the alternative route, that is, the HD route, is LaneGroup 1+LaneGroup 2 (which is a route 1) and LaneGroup 1+LaneGroup 3 (which is a route 2). It may be obtained through calculation that a heading difference between the route 1 and the SD route is small, a distance between the route 1 and the SD route is small, and there are more points in the SD route falling within the route 1. It may be determined based on the foregoing descriptions that the HD route is LaneGroup 1+LaneGroup 2.

When the similarity parameter between the preset navigation route and each of the alternative routes is determined, this embodiment of the present disclosure provides a manner of determining the similarity parameter in a plurality of data dimensions, so that an appropriate data dimension can be selected to calculate the similarity parameter in different determining accuracy, requirements, application scenarios, or data obtaining conditions, to effectively improve an application scope and application flexibility of the present disclosure.

In this solution, the user can learn in advance whether the user is to depart/has departed from the route several hundred m before an area such as the main and side roads, and the crossroad. This embodiment of the present disclosure can provide more accurate and user-friendly lane-level guidance for the user.

This embodiment of the present disclosure provides a lane-level guidance solution for yawing. To be specific, on the premise that the vehicle implements lane-level positioning, whether the vehicle departs from the current navigation route can be perceived in advance, to re-plan a route for the user in advance before the vehicle yaws, so that travelling time consumption caused by yawing is avoided. In this embodiment of the present disclosure, if it is detected that the vehicle cannot subsequently travel according to the preset route, the user may be reminded that the vehicle is to yaw, and the travelling route of the vehicle is re-planned. The solutions of the present disclosure may be applied to lane-level yawing recognition in a scenario of an urban expressway, thereby serving an L2-level autonomous driving industry.

To better implement the foregoing method, an embodiment of the present disclosure further provides a navigation apparatus. The navigation apparatus may be specifically integrated into an electronic device. The electronic device may be a device such as a terminal or a server. The terminal may be a device such as a mobile phone, a tablet computer, a smart Bluetooth device, a notebook computer, or a personal computer. The server may be a single server, or may be a server cluster including at least one server.

For example, in this embodiment, the method of this embodiment of the present disclosure is described in detail by using an example in which the navigation apparatus is specifically integrated into the terminal.

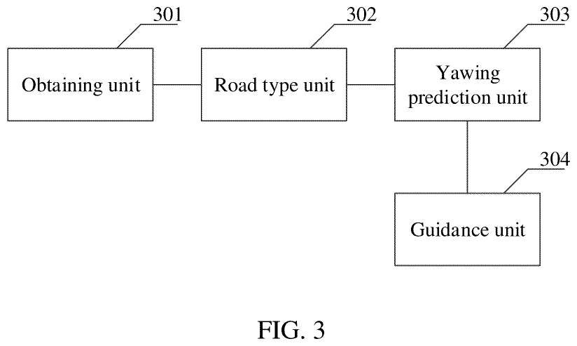

For example, as shown in FIG. 3, the navigation apparatus may include an obtaining unit 301, a road type unit 302, a yawing prediction unit 303, and a guidance unit 304. Details are as follows:

(1) Obtaining unit 301.

The obtaining unit 301 is configured to obtain a current position and a current navigation route of a vehicle.

(2) Road type unit 302.

The road type unit 302 is configured to determine a road type of a road on which the current position is located in a high definition map.

In some embodiments, the road includes a lane group, the lane group includes a lane, and the road type unit 302 is configured to:
determine a quantity of downstream lane groups of a current lane group, the current lane group being a lane group in which the current position is located in the high definition map; and
determine the road type of the road on which the current position is located in the high definition map as a non-diverging road type when the quantity of downstream lane groups of the current lane group is 1; and/or
determine the road type of the road on which the current position is located in the high definition map as a diverging road type when the quantity of downstream lane groups of the current lane group is greater than 1.

(3) Yawing prediction unit 303.

The yawing prediction unit 303 is configured to: when the road type is the diverging road type, predict, based on the current position in the high definition map, a yawing probability that the vehicle departs from the current navigation route.

In some embodiments, the yawing prediction unit 303 includes a definition conversion subunit and a yawing prediction subunit.

(1) The definition conversion subunit is configured to: when the road type is the diverging road type, perform definition conversion on a preset navigation route, to obtain a high definition navigation route.

(2) The yawing prediction subunit is configured to predict, based on the current position in the high definition map, a yawing probability that the vehicle departs from the high definition navigation route.

In some embodiments, the definition conversion subunit includes:
an alternative route sub-module, configured to determine alternative routes based on the high definition map, the current position of the vehicle being located in the alternative route; and
a route determining sub-module, configured to determine, from the alternative routes, a route that is most similar to the preset navigation route as the high definition navigation route.

In some embodiments, the route determining sub-module is configured to:
determine a similarity parameter between each of the alternative routes and the preset navigation route; and
determine, based on the similarity parameter, a most similar route from the alternative routes as the high definition navigation route.

In some embodiments, the similarity parameter includes a heading difference, and the determine a similarity parameter between each of the alternative routes and the preset navigation route includes:
obtaining headings of the alternative routes and the preset navigation route; and
calculating a heading difference between each of the alternative routes and the preset navigation route based on the headings of the alternative routes and the preset navigation route.

In some embodiments, the similarity parameter includes an overlapping degree, the preset navigation route includes preset navigation route points, and the determine a similarity parameter between each of the alternative routes and the preset navigation route includes:
determining an overlapping point in the preset navigation route points, the overlapping point being a preset navigation route point overlapping the alternative route; and
determining an overlapping degree between the preset navigation route and each of the alternative routes based on a quantity of overlapping points.

In some embodiments, the similarity parameter includes a relative distance, and the determine a similarity parameter between each of the alternative routes and the preset navigation route includes:
obtaining route locations of the alternative routes and the preset navigation route; and
calculating a relative distance between each of the alternative routes and the preset navigation route, based on the route locations of the alternative routes and the preset navigation route.

In some embodiments, the similarity parameter includes an association degree, and the determine a similarity parameter between each of the alternative routes and the preset navigation route includes:
obtaining the association relationship between each of the alternative routes and the preset navigation route; and
calculating an association degree between the preset navigation route and each of the alternative routes, based on the association relationship between each of the alternative routes and the preset navigation route.

In some embodiments, the determine a most similar high definition navigation route in the alternative routes, based on the similarity parameter (or the determine, based on the similarity parameter, a most similar route from the alternative routes as the high definition navigation route) includes:
determining a comprehensive similarity parameter between each of the alternative routes and the preset navigation route, based on the heading difference, the relative distance, the overlapping degree, and the association degree; and
determining, based on the comprehensive similarity parameter, a most similar route from the alternative routes as the high definition navigation route.

In some embodiments, the road includes the lane group, the lane group includes the lane, the road includes a diverging surface, the current navigation route is the high definition navigation route, and the yawing prediction unit 303 includes:
a crossing quantity subunit, configured to determine, based on the high definition map, a crossing quantity of lanes crossed by the vehicle to travel from a start lane to an end lane group, the start lane being a lane that is in the current navigation route and from which the vehicle travels from the current position of the vehicle to the diverging surface, the end lane group including an end lane, and the end lane being a lane adjacent to the diverging surface in the current navigation route;
a lane crossing distance subunit, configured to determine a minimum lane crossing distance required by the vehicle to cross the crossing quantity of lanes in a current travelling status;
a first value subunit, configured to determine the yawing probability as a first value, If the minimum lane crossing distance is less than a current buffer distance, where the first value represents that the vehicle is not to depart from the current navigation route; and
a second value subunit, configured to determine the yawing probability as a second value if the minimum lane crossing distance is not less than the current buffer distance, the second value representing that the vehicle is to depart from the current navigation route, and the current buffer distance being a distance between the current position and a position at a preset length before the diverging surface. In some implementations, the position at the preset length before the diverging surface may also be referred as a position at a preset distance in front of the diverging surface.

In some embodiments, the yawing prediction unit 303 is further configured to:
obtain traffic indication information;
determine, based on the traffic indication information, a traffic status of the end lane to which the vehicle travels from the start lane; and
determine the yawing probability as the second value if the traffic status of the end lane is a closed-to-traffic state.

(4) Guidance unit 304.

The guidance unit 304 is configured to generate a re-planned route based on the yawing probability, to guide the vehicle to travel according to the re-planned route.

In some embodiments, the guidance unit 304 is configured to:
guide the vehicle into the end lane group if the yawing probability is the first value; or
generate the re-planned route and guide the vehicle to travel according to the re-planned route if the yawing probability is the second value.

During specific implementation, the foregoing units may be implemented as independent entities, may be combined in any manner, or may be implemented as a same entity or several entities. For specific implementations of the foregoing units, refer to the foregoing method embodiments. Details are not described herein again.

In the navigation apparatus of this embodiment, the obtaining unit obtains the current position and the current navigation route of the vehicle. The road type unit determines the road type of the road on which the current position is located in the high definition map. When the road type is the diverging road type, the yawing prediction unit predicts, based on the current position in the high definition map, the yawing probability that the vehicle departs from the current navigation route. The guidance unit generates the re-planned route based on the yawing probability, to guide the vehicle to travel according to the re-planned route.

In this way, in this embodiment of the present disclosure, yawing of the vehicle can be perceived in advance, to provide a suitable guidance service for the user in advance.

An embodiment of the present disclosure further provides an electronic device. The electronic device may be a device such as a terminal or a server. The terminal may be a mobile phone, a tablet computer, a smart Bluetooth device, a notebook computer, a personal computer, or the like. The server may be a single server, may be a server cluster including at least one server, or the like.

In some embodiments, the navigation apparatus may alternatively be integrated into at least one electronic device. For example, the navigation apparatus may be integrated into at least one server, and the at least one server implements the navigation method in the present disclosure.

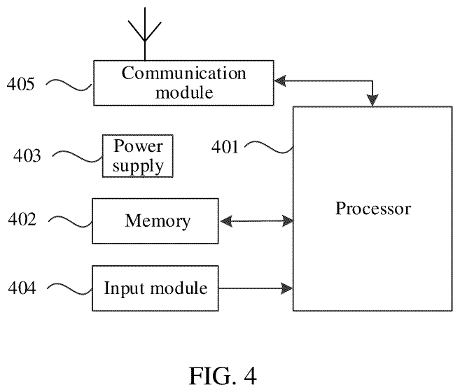

In this embodiment, an example in which the electronic device in this embodiment is a vehicle-mounted terminal or a smartphone is used for detailed description. For example, FIG. 4 is a schematic diagram of a structure of the electronic device according to an embodiment of the present disclosure. Details are as follows.

The electronic device may include components such as a processor 401 including one or more processing cores, a memory 402 including one or more computer-readable storage media, a power supply 403, an input module 404, and a communication module 405. A person skilled in the art may understand that the structure of the electronic device shown in FIG. 4 does not constitute a limitation on the electronic device, and the electronic device may include more components or fewer components than those shown in the figure, or some components may be combined, or in different component arrangements.

The processor 401 is a control center of the electronic device, is connected to various parts of the entire electronic device by using various interfaces and lines, runs or executes a software program and/or module stored in the memory 402, and invokes data stored in the memory 402, to perform various functions of the electronic device and processes data, so as to detect the entire electronic device. In some embodiments, the processor 401 may include one or at least one processing core. In some embodiments, the processor 401 may integrate an application processor and a modem processor. The application processor mainly processes an operating system, a user interface, an application program, and the like. The modem processor mainly processes wireless communication. The foregoing modem may alternatively not be integrated into the processor 401.

The memory 402 may be configured to store the software program and module. The processor 401 runs the software program and module stored in the memory 402, to implement various functional applications and data processing. The memory 402 may mainly include a program storage area and a data storage area. The program storage area may store an operating system, an application program required by at least one function (such as a sound playback function or an image display function), and the like. The data storage area may store data created based on use of the electronic device, and the like. In addition, the memory 402 may include a high-speed random access memory, and may further include a non-volatile memory such as at least one magnetic disk storage device or a flash memory device, or another volatile solid storage device. Correspondingly, the memory 402 may further include a memory controller, to provide the processor 401 with access to the memory 402.

The electronic device further includes the power supply 403 for supplying power to the components. In some embodiments, the power supply 403 may be logically connected to the processor 401 by using a power supply management system, thereby implementing functions, such as charging, discharging, and power consumption management, by using the power supply management system. The power supply 403 may further include any component such as one or more direct current or alternating current power supplies, a re-charging system, a power failure detection circuit, a power supply converter or inverter, or a power supply state indicator.

The electronic device may further include the input module 404. The input module 404 may be configured to receive input digit or character information, and generate input of a keyboard, a mouse, a joystick, or an optical or track ball signal that are related to the user setting and function control.

The electronic device may further include the communication module 405. In some embodiments, the communication module 405 may include a wireless module. The electronic device may perform short-distance wireless transmission through the wireless module in the communication module 405, to provide the user with wireless broadband Internet access. For example, the communication module 405 may be configured to help the user receive and send an e-mail, browse a web page, and access a streaming medium.

Although not shown in the figure, the electronic device may further include a display unit and the like. Details are not described herein. Specifically, in this embodiment, the processor 401 in the electronic device loads executable files corresponding to processes of the one or more applications to the memory 402 according to the following instructions, and the processor 401 runs the application in the memory 402, to implement various functions, including:
obtaining a current position and a current navigation route of a vehicle;
determining a road type of a road on which the current position is located in a high definition map;
when the road type is a diverging road type, predicting, based on the current position in the high definition map, a yawing probability that the vehicle departs from the current navigation route; and
generating a re-planned route based on the yawing probability, to guide the vehicle to travel according to the re-planned route. For specific implementations of the foregoing operations, refer to the foregoing embodiments. Details are not described herein again.

In this embodiment of the present disclosure, yawing of the vehicle may be perceived in advance, to provide a suitable guidance service for the user in advance.

A person of ordinary skill in the art could understand that, all or some operations of various methods in the embodiments may be implemented through instructions, or implemented through instructions controlling relevant hardware, and the instructions may be stored in the computer-readable storage medium and be loaded and executed by the processor.

Therefore, an embodiment of the present disclosure provides a computer-readable storage medium. The storage medium is configured to store a computer program, and the computer program is configured to perform operations in any navigation method provided in the embodiments of the present disclosure. For example, the instructions may be configured for performing the following operations:
obtaining a current position and a current navigation route of a vehicle;
determining a road type of a road on which the current position is located in a high definition map;
when the road type is a diverging road type, predicting, based on the current position in the high definition map, a yawing probability that the vehicle departs from the current navigation route; and
generating a re-planned route based on the yawing probability, to guide the vehicle to travel according to the re-planned route.

The storage medium may include: a read-only memory (ROM), a random access memory (RAM), a magnetic disk, an optical disc, or the like.

According to an aspect of the present disclosure, an embodiment of the present disclosure further provides a computer program product including a computer program, and the computer program product, when running on a computer product, enables the computer to perform the method provided in the foregoing embodiment.

Because the computer program stored in a storage medium can be configured for performing operations in the navigation method provided in the embodiment of the present disclosure, the computer program can achieve beneficial effects that can be implemented by any navigation method provided in the embodiments of the present disclosure. For details, refer to the foregoing embodiments, and details are not described herein.

The navigation method and apparatus, the electronic device, the computer-readable storage medium, and the program product provided in the embodiments of the present disclosure are described above in detail. Principles and implementations of the present disclosure are described in this specification by using specific examples. The descriptions of the foregoing embodiments are merely intended to help understand the method and core ideas of the present disclosure. Meanwhile, a person skilled in the art may make modifications to the specific implementations and application scopes according to the ideas of the present disclosure. In conclusion, the content of this specification should not be construed as a limitation to the present disclosure.

In various embodiments in the present disclosure, a unit (or a subunit) may refer to a software unit, a hardware unit, or a combination thereof. A software unit may include a computer program or part of the computer program that has a predefined function and works together with other related parts to achieve a predefined goal, such as those functions described in this disclosure. A hardware unit may be implemented using processing circuitry and/or memory configured to perform the functions described in this disclosure. Each unit can be implemented using one or more processors (or processors and memory). Likewise, a processor (or processors and memory) can be used to implement one or more units. Moreover, each unit can be part of an overall unit that includes the functionalities of the unit. The description here also applies to the term unit and other equivalent terms.

In various embodiments in the present disclosure, a module (or a sub-module) may refer to a software module, a hardware module, or a combination thereof. A software module may include a computer program or part of the computer program that has a predefined function and works together with other related parts to achieve a predefined goal, such as those functions described in this disclosure. A hardware module may be implemented using processing circuitry and/or memory configured to perform the functions described in this disclosure. Each module can be implemented using one or more processors (or processors and memory). Likewise, a processor (or processors and memory) can be used to implement one or more modules. Moreover, each module can be part of an overall module that includes the functionalities of the module. The description here also applies to the term module and other equivalent terms.

In some other embodiments, a computer-readable medium comprising instructions which, when executed by a computer, cause the computer to carry out a portion or all of the above methods. The computer-readable medium may be referred as non-transitory computer-readable media (CRM) that stores data for extended periods such as a flash drive or compact disk (CD), or for short periods in the presence of power such as a memory device or random access memory (RAM). In some embodiments, computer-readable instructions may be included in a software, which is embodied in one or more tangible, non-transitory, computer-readable media. Such non-transitory computer-readable media can be media associated with user-accessible mass storage as well as certain short-duration storage that are of non-transitory nature, such as internal mass storage or ROM. The software implementing various embodiments of the present disclosure can be stored in such devices and executed by a processor (or processing circuitry). A computer-readable medium can include one or more memory devices or chips, according to particular needs. The software can cause the processor (including CPU, GPU, FPGA, and the like) to execute particular processes or particular parts of particular processes described herein, including defining data structures stored in RAM and modifying such data structures according to the processes defined by the software. In various embodiments in the present disclosure, the term “processor” may mean one processor that performs the defined functions, steps, or operations or a plurality of processors that collectively perform defined functions, steps, or operations, such that the execution of the individual defined functions may be divided amongst such plurality of processors.

What are disclosed above are merely examples of embodiments of this application, and certainly are not intended to limit the protection scope of this application. Therefore, equivalent variations made in accordance with the claims of this application shall fall within the scope of this application.

What is claimed is:

1. A navigation method, executed by an electronic device comprising a memory and a processor in communication with the memory, the method comprising:
obtaining a current position and a current navigation route of a vehicle;
determining a road type of a road on which the current position is located in a high definition map;
in response to the road type being determined as a diverging road type, predicting, based on the current position in the high definition map, a yawing probability that the vehicle departs from the current navigation route; and
generating a re-planned route based on the yawing probability, to guide the vehicle to travel according to the re-planned route.

2. The navigation method according to claim 1, wherein:
the road comprises a lane group,
the lane group comprises a lane, and
the determining the road type of the road on which the current position is located in the high definition map comprises:
determining a quantity of downstream lane groups of a current lane group, the current lane group being a lane group in which the current position is located in the high definition map; and
determining the road type of the road on which the current position is located in the high definition map as a non-diverging road type when the quantity of downstream lane groups of the current lane group is 1; or
determining the road type of the road on which the current position is located in the high definition map as the diverging road type when the quantity of downstream lane groups of the current lane group is greater than 1.

3. The navigation method according to claim 1, wherein:
the current navigation route is a preset navigation route, and
in response to the road type being determined as the diverging road type, the predicting, based on the current position in the high definition map, the yawing probability that the vehicle departs from the current navigation route comprises:
in response to the road type being determined as the diverging road type, performing definition conversion on the preset navigation route, to obtain a high definition navigation route; and
predicting, based on the current position in the high definition map, the yawing probability that the vehicle departs from the high definition navigation route.

4. The navigation method according to claim 3, wherein the performing the definition conversion on the preset navigation route, to obtain the high definition navigation route comprises:
determining alternative routes based on the high definition map, the current position of the vehicle being located in the alternative routes; and
determining, from the alternative routes, a route that is most similar to the preset navigation route as the high definition navigation route.

5. The navigation method according to claim 4, wherein the determining, from the alternative routes, the route that is most similar to the preset navigation route as the high definition navigation route comprises:
determining a similarity parameter between each of the alternative routes and the preset navigation route; and
determining, based on the similarity parameters, a most similar route from the alternative routes as the high definition navigation route.

6. The navigation method according to claim 5, wherein:
the similarity parameter comprises a heading difference, and
the determining the similarity parameter between each of the alternative routes and the preset navigation route comprises:
obtaining headings of the alternative routes and the preset navigation routes; and
calculating a heading difference between each of the alternative routes and the preset navigation route based on the headings of the alternative routes and the preset navigation route.

7. The navigation method according to claim 5, wherein:
the similarity parameter comprises an overlapping degree,
the preset navigation route comprises preset navigation route points, and
the determining the similarity parameter between each of the alternative routes and the preset navigation route comprises:
determining an overlapping point in the preset navigation route points, the overlapping point being a preset navigation route point overlapping the alternative route; and
determining an overlapping degree between the preset navigation route and each of the alternative routes based on a quantity of overlapping points.

8. The navigation method according to claim 5, wherein:
the similarity parameter comprises a relative distance, and
the determining the similarity parameter between each of the alternative routes and the preset navigation route comprises:
obtaining route locations of the alternative routes and the preset navigation route; and
calculating a relative distance between each of the alternative routes and the preset navigation route based on the route locations of the alternative routes and the preset navigation route.

9. The navigation method according to claim 5, wherein:
the similarity parameter comprises an association degree, and
the determining the similarity parameter between each of the alternative routes and the preset navigation route comprises:
obtaining an association relationship between each of the alternative routes and the preset navigation route; and
calculating an association degree between the preset navigation route and each of the alternative routes based on the association relationship between each of the alternative routes and the preset navigation route.

10. The navigation method according to claim 1, wherein:
the road comprises a lane group,
the lane group comprises a lane,
the road comprises a diverging surface,
the current navigation route is a high definition navigation route, and
the predicting, based on the current position in the high definition map, the yawing probability that the vehicle departs from the current navigation route comprises:
determining, based on the high definition map, a crossing quantity of lanes crossed by the vehicle to travel from a start lane to an end lane group, the start lane being a lane that is in the current navigation route and from which the vehicle travels from the current position of the vehicle to the diverging surface, the end lane group comprising an end lane, and the end lane being a lane adjacent to the diverging surface in the current navigation route;
determining a minimum lane crossing distance required by the vehicle to cross the crossing quantity of lanes in a current travelling status; and
determining the yawing probability as a first value in response to the minimum lane crossing distance being less than a current buffer distance, the first value representing that the vehicle is not to depart from the current navigation route; or
determining the yawing probability as a second value in response to the minimum lane crossing distance being not less than the current buffer distance, the second value representing that the vehicle is to depart from the current navigation route,
wherein the current buffer distance is a distance between the current position and a position at a preset length before the diverging surface.

11. The navigation method according to claim 10, wherein the predicting, based on the current position in the high definition map, the yawing probability that the vehicle departs from the current navigation route comprises:
obtaining traffic indication information;
determining, based on the traffic indication information, a traffic status of the end lane to which the vehicle travels from the start lane; and
determining the yawing probability as the second value in response to the traffic status of the end lane being a closed-to-traffic state.

12. An apparatus for determining a target image region of a target object in a target image, the apparatus comprising:
a memory storing instructions; and
a processor in communication with the memory, wherein, when the processor executes the instructions, the processor is configured to cause the apparatus to perform:
obtaining a current position and a current navigation route of a vehicle;
determining a road type of a road on which the current position is located in a high definition map;
in response to the road type being determined as a diverging road type, predicting, based on the current position in the high definition map, a yawing probability that the vehicle departs from the current navigation route; and
generating a re-planned route based on the yawing probability, to guide the vehicle to travel according to the re-planned route.

13. The apparatus according to claim 12, wherein:
the road comprises a lane group,
the lane group comprises a lane, and
when the processor is configured to cause the apparatus to perform determining the road type of the road on which the current position is located in the high definition map, the processor is configured to cause the apparatus to perform:
determining a quantity of downstream lane groups of a current lane group, the current lane group being a lane group in which the current position is located in the high definition map; and
determining the road type of the road on which the current position is located in the high definition map as a non-diverging road type when the quantity of downstream lane groups of the current lane group is 1; or
determining the road type of the road on which the current position is located in the high definition map as the diverging road type when the quantity of downstream lane groups of the current lane group is greater than 1.

14. The apparatus according to claim 12, wherein:
the current navigation route is a preset navigation route, and
when the processor is configured to cause the apparatus to perform, in response to the road type being determined as the diverging road type, predicting, based on the current position in the high definition map, the yawing probability that the vehicle departs from the current navigation route, the processor is configured to cause the apparatus to perform:
in response to the road type being determined as the diverging road type, performing definition conversion on the preset navigation route, to obtain a high definition navigation route; and
predicting, based on the current position in the high definition map, the yawing probability that the vehicle departs from the high definition navigation route.

15. The apparatus according to claim 14, wherein, when the processor is configured to cause the apparatus to perform performing the definition conversion on the preset navigation route, to obtain the high definition navigation route, the processor is configured to cause the apparatus to perform:
determining alternative routes based on the high definition map, the current position of the vehicle being located in the alternative routes; and
determining, from the alternative routes, a route that is most similar to the preset navigation route as the high definition navigation route.

16. The apparatus according to claim 15, wherein, when the processor is configured to cause the apparatus to perform determining, from the alternative routes, the route that is most similar to the preset navigation route as the high definition navigation route, the processor is configured to cause the apparatus to perform:
determining a similarity parameter between each of the alternative routes and the preset navigation route; and
determining, based on the similarity parameters, a most similar route from the alternative routes as the high definition navigation route.

17. The apparatus according to claim 12, wherein:
the road comprises a lane group,
the lane group comprises a lane,
the road comprises a diverging surface,
the current navigation route is a high definition navigation route, and
when the processor is configured to cause the apparatus to perform predicting, based on the current position in the high definition map, the yawing probability that the vehicle departs from the current navigation route, the processor is configured to cause the apparatus to perform:
determining, based on the high definition map, a crossing quantity of lanes crossed by the vehicle to travel from a start lane to an end lane group, the start lane being a lane that is in the current navigation route and from which the vehicle travels from the current position of the vehicle to the diverging surface, the end lane group comprising an end lane, and the end lane being a lane adjacent to the diverging surface in the current navigation route;
determining a minimum lane crossing distance required by the vehicle to cross the crossing quantity of lanes in a current travelling status; and
determining the yawing probability as a first value in response to the minimum lane crossing distance being less than a current buffer distance, the first value representing that the vehicle is not to depart from the current navigation route; or
determining the yawing probability as a second value in response to the minimum lane crossing distance being not less than the current buffer distance, the second value representing that the vehicle is to depart from the current navigation route,
wherein the current buffer distance is a distance between the current position and a position at a preset length before the diverging surface.

18. A non-transitory computer-readable storage medium, storing computer-readable instructions, wherein, the computer-readable instructions, when executed by a processor, are configured to cause the processor to perform:
obtaining a current position and a current navigation route of a vehicle;
determining a road type of a road on which the current position is located in a high definition map;
in response to the road type being determined as a diverging road type, predicting, based on the current position in the high definition map, a yawing probability that the vehicle departs from the current navigation route; and
generating a re-planned route based on the yawing probability, to guide the vehicle to travel according to the re-planned route.

19. The non-transitory computer-readable storage medium according to claim 18, wherein:
the road comprises a lane group,
the lane group comprises a lane, and
when the computer-readable instructions are configured to cause the processor to perform determining the road type of the road on which the current position is located in the high definition map, the computer-readable instructions are configured to cause the processor to perform:
determining a quantity of downstream lane groups of a current lane group, the current lane group being a lane group in which the current position is located in the high definition map; and
determining the road type of the road on which the current position is located in the high definition map as a non-diverging road type when the quantity of downstream lane groups of the current lane group is 1; or
determining the road type of the road on which the current position is located in the high definition map as the diverging road type when the quantity of downstream lane groups of the current lane group is greater than 1.

20. The non-transitory computer-readable storage medium according to claim 18, wherein:
the road comprises a lane group,
the lane group comprises a lane,
the road comprises a diverging surface,
the current navigation route is a high definition navigation route, and
when the computer-readable instructions are configured to cause the processor to perform predicting, based on the current position in the high definition map, the yawing probability that the vehicle departs from the current navigation route, the computer-readable instructions are configured to cause the processor to perform:
determining, based on the high definition map, a crossing quantity of lanes crossed by the vehicle to travel from a start lane to an end lane group, the start lane being a lane that is in the current navigation route and from which the vehicle travels from the current position of the vehicle to the diverging surface, the end lane group comprising an end lane, and the end lane being a lane adjacent to the diverging surface in the current navigation route;
determining a minimum lane crossing distance required by the vehicle to cross the crossing quantity of lanes in a current travelling status; and
determining the yawing probability as a first value in response to the minimum lane crossing distance being less than a current buffer distance, the first value representing that the vehicle is not to depart from the current navigation route; or
determining the yawing probability as a second value in response to the minimum lane crossing distance being not less than the current buffer distance, the second value representing that the vehicle is to depart from the current navigation route,
wherein the current buffer distance is a distance between the current position and a position at a preset length before the diverging surface.
